(19) United States
(12) Patent Application Publication
(10) Pub. No.: US 2015/0120347 A1
(43) Pub. Date: Apr. 30, 2015

(54) SYSTEM AND METHOD FOR UPDATING ORGANIZATION FAMILY TREE INFORMATION

(71) Applicant: The Dun & Bradstreet Corporation, Short Hills, NJ (US)

(72) Inventors: Brendan BINEDELL, Dublin (IE); James WHITE, Dublin (IE); Cian CRADDOCK, Dublin (IE); Maxime BROUSSARD, Dublin (IE); Andrew DOYLE, Dublin (IE); Tony RYAN, Dublin (IE); Claire BACON, Dublin (IE)

(73) Assignee: The Dun & Bradstreet Corporation, Short Hills, NJ (US)

(21) Appl. No.: 14/091,633

(22) Filed: Nov. 27, 2013

Related U.S. Application Data
(60) Provisional application No. 61/731,994, filed on Nov. 30, 2012.

(51) Int. Cl. G06Q 10/10; G06F 17/30

(52) U.S. Cl. CPC G06Q 10/10; G06F 17/30221; G06F 17/30368
USPC 705/7.11

(57) ABSTRACT

A system and a method for updating hierarchical family trees of organizations having related corporate members. The system includes a data processor; a memory for storing instructions for operation of the data processor, the instructions causing the processor to perform steps of accessing a comprehensive linkage repository having corporate linkage data stored therein; determining changes in the corporate linkage data; generating a change file representative of the changes in the corporate linkage data; using the change file to generate exceptions to the corporate linkage data stored in the repository; generating an updated hierarchical family tree in accordance with the exceptions; and storing the updated hierarchical family tree.

### CROSS-REFERENCED APPLICATION

This application claims priority from and the benefit of provisional patent application Ser. No. 61/731,994 filed on Nov. 30, 2012, which is incorporated herein by reference, for all purposes, in its entirety.

### BACKGROUND

1. Field of the Disclosure

The present disclosure generally relates to business information services. In particular, the present disclosure relates to corporate families, business information, linkage, multinational corporations, business intelligence, and global data collection.

2. Description of the Related Art

As described in U.S. Pat. No. 8,036,907, some providers of corporate linkage information deliver incomplete, inaccurate, and outdated information. Often, data comes only from annual reports or is updated quarterly. Fragmented and uncoordinated update processes drive quality down and costs up. The conventional one-record-at-a-time approach to linkage information maintenance has reduced effectiveness. For example, local updates that are uncoordinated with global updates can introduce inconsistencies and errors. There is a need for a provider to pro-actively seek out changes in corporate linkage information and provide complete, accurate and timely information.

There is a need for monitoring of changes to company data, such as ownership. Ownership data needs to be identified and stored to provide more complete and accurate lists of corporate linkage so that customers are provided with the most up to date data. There is a need for updating stored information with information from companies themselves as well as third parties through a matching process. This reduces the time and effort needed to make these comparisons and improve the consistency and accuracy of the comparisons. There is also a need to automate manual processes to enable them to be repeated periodically and to implement a monitoring process to identify changes. This provides more complete and accurate corporate linkages.

There is a need for batch updates to global files to ensure data is updated correctly and consistently. This eliminates data entry mistakes and increases speed of updates. This provides more complete corporate linkage.

### SUMMARY OF THE DISCLOSURE

There is provided a system and method that identifies daily changes in company linkage.

There is further provided a system and method that compares daily changes to a source of truth (SOT) database.

There is also provided a system and method for investigating and confirming changes in company linkage which is ultimately stored in a database for further analysis.

There is further provided a system and method that avoids the need to evaluate linkages for which no change data is obtained.

The process disclosed herein is designed to evaluate daily changes acquired from Dun & Bradstreet, Inc.'s GLR to investigate only those changes. A change list from GLR (a delta or change file) is processed and compared to the SOT. This means that only the exceptions are being investigated each day, as opposed to all the linkage data. This has the advantage of permitting daily updates of the linkage data, rather than going through the entire database, and due to time limitations, updating particular linkage data on average, only once a year.

The present disclosure provides a computer readable non-transitory storage medium storing instructions of a computer program that when executed by a computer system results in performance of steps for creating and operating the system and executing the method.

The disclosure is directed to a system and a method for updating hierarchical family trees of organizations having related corporate members. The system comprises a data processor; a memory for storing instructions for operation of the data processor, the instructions causing the processor to perform steps of: accessing a comprehensive linkage repository having corporate linkage data stored therein; determining changes in the corporate linkage data; generating a change file representative of the changes in the corporate linkage data; using the change file to generate exceptions to the corporate linkage data stored in the repository; generating an updated hierarchical family tree in accordance with the exceptions; and storing the updated hierarchical family tree.

Further instructions can cause the processor to perform steps of comparing contents of the repository at a first time to contents of the repository at a second time to generate the change file.

Further instructions can cause the processor to perform steps of: providing a copy of the data in the repository at a first time; acquiring additional or changed corporate linkage data; generating a changed copy of the data in the repository at a first time having the additional or changed data therein; and comparing the changed copy of the data in the repository with the copy of the data in the repository at the first time to generate the change file.

Further instructions cause the processor to acquire a list of additional or changed corporate linkage data; obtain from the repository the hierarchical family trees of organizations on the list; store the hierarchical family trees of organizations on the list in a database; and compare the stored hierarchical family trees to those of a database of known accuracy to generate the change file.

The system further comprises instructions for queuing the exception to a user interface for action by a user, so that the user makes a decision concerning the exception.

The system further comprising instructions for providing inquiry paths for consulting official sources to investigate whether the exception is correct.

The system further comprising instructions for receiving inputs for resolving an exception that is correct by an action selected from the group consisting of: promoting an entity, relinking an entity, delinking an entity, adding an entity and demoting an entity.

The system further comprising instructions for making an inquiry as to the effect of the delinking an entity.

The system further comprising instructions for making an inquiry as to whether there are additional items to consider concerning the effect of the delinking of an entity.

The system further comprising instructions for entering at least one decision selected from the group consisting of: a confirmation, a resolution source, a resolution reason and a type of resolution, for the exception.

The disclosure is also directed to a method for updating hierarchical family trees of organizations having related corporate members comprising: accessing a comprehensive linkage repository having corporate linkage data stored therein; determining changes in the corporate linkage data; generating a change file representative of the changes in the corporate linkage data; using the change file to generate exceptions to the corporate linkage data stored in the repository; generating an updated hierarchical family tree in accordance with the exceptions; and storing on a storage medium the updated hierarchical family tree.

The method can further comprise comparing contents of the repository at a first time to contents of the repository at a second time to generate the change file.

The method can further comprise providing a copy of the data in the repository at a first time; acquiring additional or changed corporate linkage data; generating a changed copy of the data in the repository at a first time having the additional or changed data therein; and comparing the changed copy of the data in the repository with the copy of the data in the repository at the first time to generate the change file.

The method can further comprise: acquiring a list of additional or changed corporate linkage data; obtaining from the repository the hierarchical family trees of organizations on the list; storing the hierarchical family trees of organizations on the list in a database; comparing the stored hierarchical family trees to those of a database of known accuracy to generate the change file.

The disclosure is also directed to a computer readable non-transitory storage medium that stores instructions of a computer program that when executed by a computer system results in performance of steps comprising: accessing a comprehensive linkage repository having corporate linkage data stored therein; determining changes in the corporate linkage data; generating a change file representative of the changes in the corporate linkage data; using the change file to generate exceptions to the corporate linkage data stored in the repository; generating an updated hierarchical family tree in accordance with the exceptions; and storing on a storage medium the updated hierarchical family tree.

### BRIEF DESCRIPTION OF THE DRAWINGS

FIG. 1 is a block diagram of conventional steps for downloading and formatting a family tree.

FIG. 2 is a flow chart for conventional steps to be taken to prepare for the investigation of changes in a family tree.

FIG. 3 is a simple exception scenario diagram indicating re-linking of a business that has been sold from one parent company to another parent company according to the present disclosure.

FIG. 4 is an end-to-end high level flow chart of the process of the present disclosure for monitoring changes made to linkage in the Source of Truth.

FIG. 4A is an end-to-end high level flow chart of an additional process of the present disclosure for monitoring changes made to linkage in the Source of Truth.

FIG. 4B is an end-to-end high level flow chart of another process of the present disclosure for monitoring changes made to linkage in the Source of Truth.

FIG. 5 is a flow chart for a process dealing with a subsidiary list according to the present disclosure.

FIG. 6 is a general system architecture for the system and method of the present disclosure.

FIG. 7 illustrates data download flow for the system and method of the present disclosure.

FIG. 8 is a flow chart illustrating the exception operation of FIG. 4 in accordance the present disclosure.

FIG. 9 is a flow chart for a DSR market.

FIG. 10 is a screen shot of a data display based on downloaded family tree data.

FIG. 11 is a screen shot of a data display after formatting and completing the family tree.

FIG. 12 is a screen shot of an exceptions list.

FIG. 13 is a screen shot of an RSS feed that provides input data to the system and method disclosed herein.

FIG. 14 is a block diagram of a representative computer system for implementing the system and method

A component or a feature that is common to more than one figure is indicated with the same reference number in each figure.

### DESCRIPTION OF THE PREFERRED EMBODIMENT

### Definitions

Linkage is the relationship between companies; in other words, who owns who.

D-U-N-S Number or Subject D-U-N-S Number is the Dun and Bradstreet, Inc. unique number for identifying a particular company.

GU is the Global Ultimate. This is the ultimate top company in the tree. This company owns all companies below the global ultimate in the tree.

Parent D-U-N-S number is the corporate identification number for the owner of a company and may also be a GU.

TWEAQ is a software program used to update the database, as described herein.

GLR or Global Linkage Repository is the database (possibly on a mainframe computer) containing all Linkage data for DNB, this is the Global source of truth for Linkage data.

SOT: is Source of Truth (i.e. a cut of linkage data at a point in time, the TWEAQ software maintains this data). The Source of Truth is the known truth for TWEAQ, i.e. it is all the data that is monitored at any given point in time. Today's SOT may be different from tomorrows in that if a company is deleted by TWEAQ, then it will be dropped from tomorrow's SOT.

Exception: An exception is a change to the current linkage for any company contained in the SOT. An exception is generated when the SOT is compared to the Change/Delta file. This comparison is run every time one polls a new change file which happens at least once, and sometimes twice, every day.

Change/Delta File: A file which is generated from the GLR (Global Linkage Repository) and contains all the changes made to the stored data from the previous day; this is subsequently downloaded in COBOL format, stored and compared to SOT.

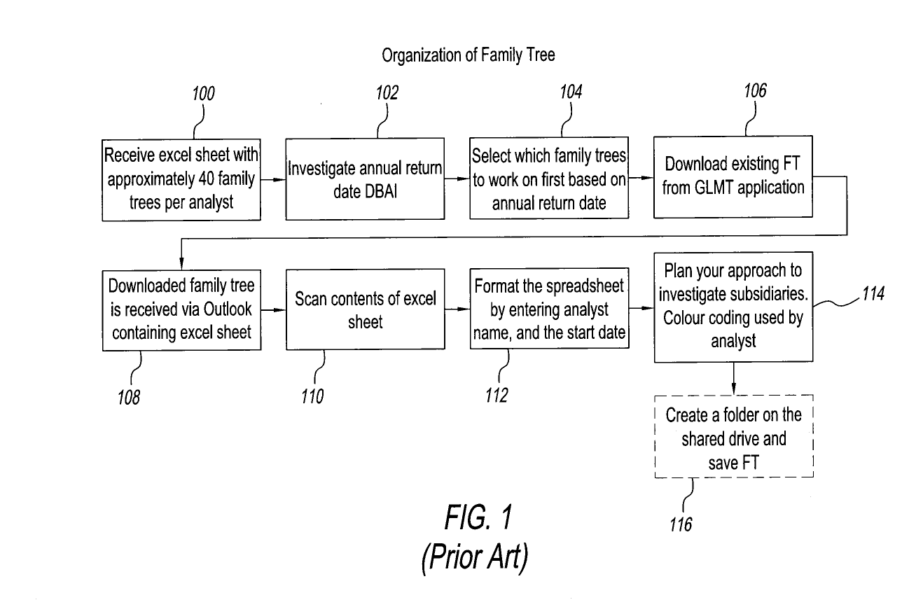

Referring to the drawings and, in particular, FIG. 1, the steps for creating an organization family tree are illustrated. At 100 a spreadsheet, which may be in Excel®, a trademark of Microsoft Corporation, with approximate forty family trees for processing by an analyst, is received. At 102 the annual return dated DBAI (Dun & Bradstreet Access for the Internet) is investigated. At 104 a selection is made as to which family trees to work on first based on annual return date. At 106 the existing family tree from the GLMT (Global Linkage Maintenance Tool) application is downloaded. At 108 the downloaded family tree is received via an e-mail application, such as Outlook®, a trademark of Microsoft Corporation, containing the spreadsheet. At 110 the contents of the spreadsheet is scanned. At 112 the spreadsheet is formatted by entering the analyst's name and start date. At 114, the approach to investigate the subsidiaries is planned. Color coding representative of the steps in the plan may be used by the analyst. At 116 a folder is created on a shared drive and the family tree is saved to that folder.

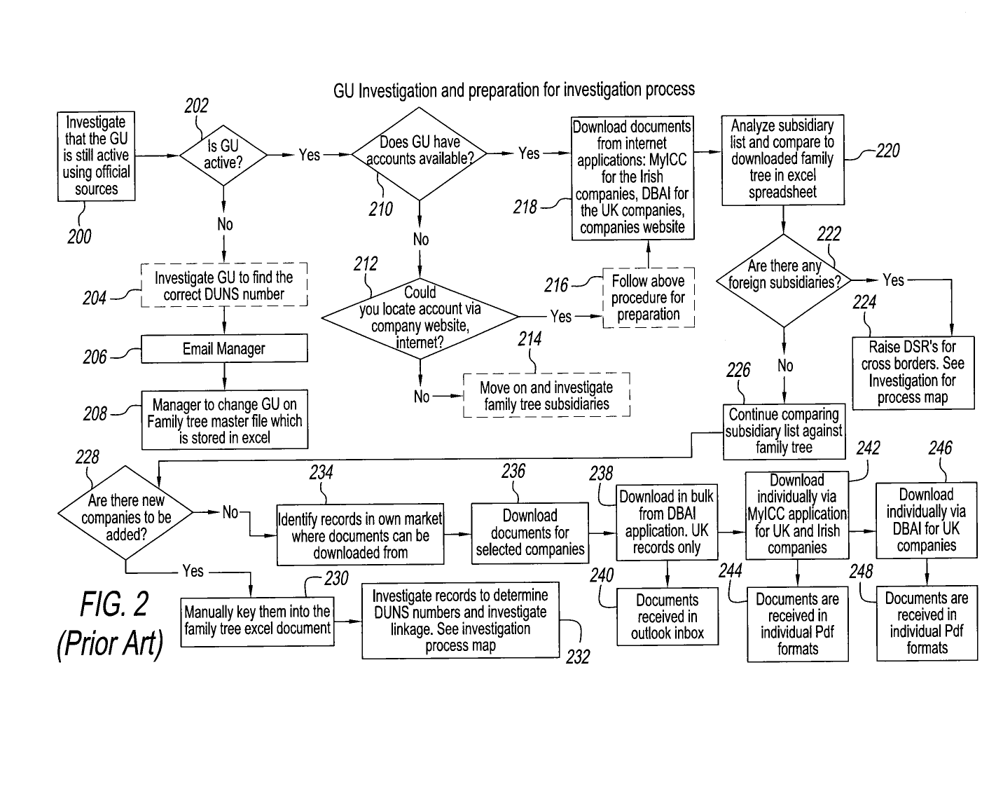

Referring to FIG. 2, steps to be taken to prepare for the investigation of changes in a family tree are illustrated. At 200 official sources are used to investigate whether the GU is still active. If the GU is determined not to be active at 202, at 204, the GU is investigated to find the correct D-U-N-S number. An e-mail is sent to a manager at 206. At 208 the manager changes the GU on the family tree master file, which is generally stored in an Excel® format.

If at 202 the GU was found to be active, a determination is made at 210 as to whether the GU has accounts available. If no accounts are available, a determination is made at 212 as to whether an account can be located via the company website or the Internet in general. If no accounts can be located at 212, investigation of the GU is suspended and at 214 entities on the next level of the family tree, such as family tree subsidiaries, are investigated. If at 212 an account is located, then at 216 the next step 218 is executed.

If the GU does have accounts available at 210 or an account is located at 212, at 218 documents from local Internet applications are downloaded; such as MyICC (Dun & Bradstreet Access for the Internet) in Ireland, DBAI for UK companies, and company websites. At 220 the subsidiary list is analyzed and compared to the downloaded family tree in the spreadsheet. At 222 a determination is made as to whether there are any foreign subsidiaries. If there are foreign subsidiaries, at 224, DSR's or cross-border applications are raised.

If at 222 there are no foreign subsidiaries, at 226 the process continues to compare the subsidiary list against the family tree. At 228 a determination is made as to whether companies are to be added to the family tree. If the answer is yes they are manually keyed in to the family tree spreadsheet document at 230. At 232 records are investigated to determine D-U-N-S numbers and linkage.

If there are no new companies to add at 228, at 234 records are identified which provide for the downloading of relevant documents. At 236, documents for selected companies are downloaded. At 238, records are downloaded in bulk from the DBAI application used in the United Kingdom. At 240, these documents are received in an e-mail inbox. At 242 documents are downloaded via the MyICC application for companies in the United Kingdom and Ireland. Generally, at 244 these documents are received in PDF format. At 246, individual documents are downloaded using the DBAI application for UK companies. At 248, these documents are received in individual PDF formats.

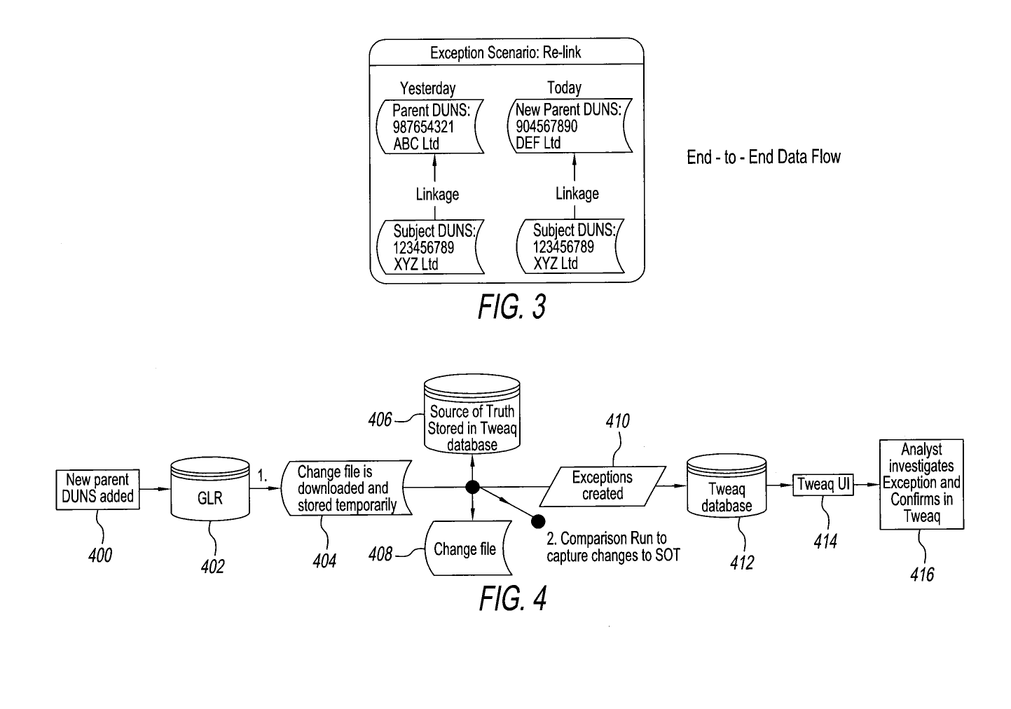

Referring to FIG. 3, a simple exception scenario is illustrated. XYZ Ltd with Subject D-U-N-S Number 123456789 was linked to ABC Ltd with Parent D-U-N-S Number 987654321. XYZ Ltd is sold and linked to a new company DEF Ltd with Parent D-U-N-S Number 904567890.

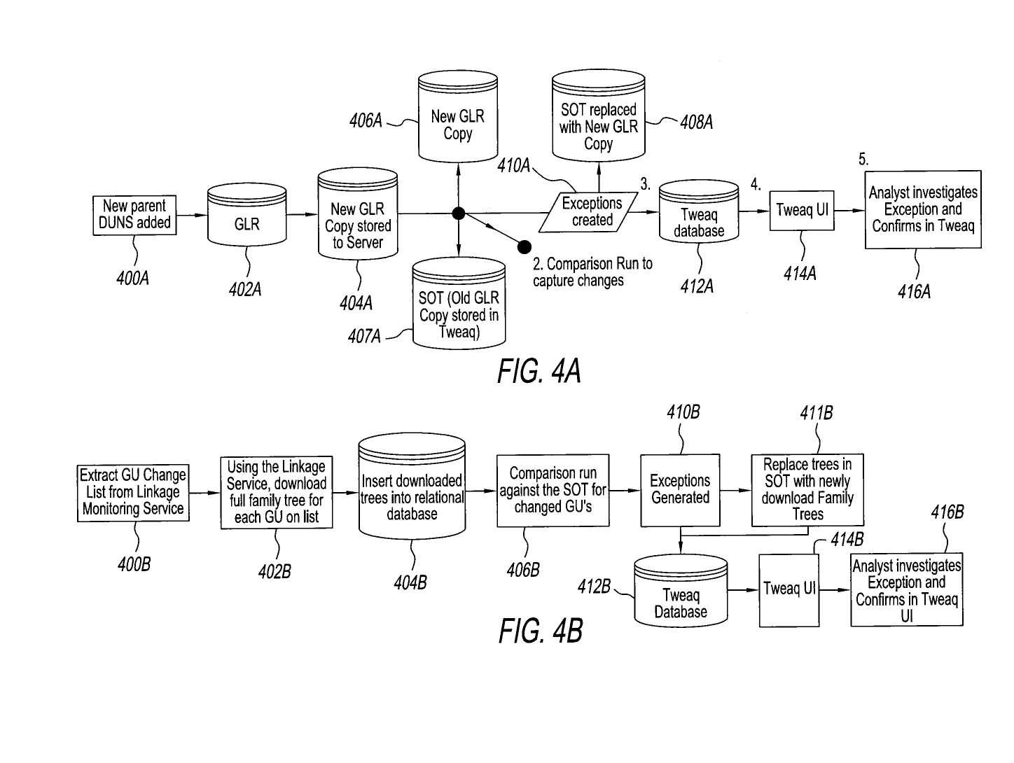

FIG. 4 is an end-to-end high level flow chart of a process disclosed herein for creating a list of exceptions. At 400, new parents D-U-N-S is added to the GLR 402. A change file 408 is downloaded and stored temporarily at 404. Change file 408 is compared to the SOT stored in the TWEAQ database 406. At 410 an exceptions file is created. At 412, the exceptions file is added to the TWEAQ database. At 414 the TWEAQ user interface is accessed. At 416 an analyst investigates exceptions and confirms the exceptions in TWEAQ.

While the logic flow of FIG. 4 may have certain advantages, in some cases it may contain a great deal of data, covering many subjects that do not relate to a change in corporate linkage. This may increase unnecessary workload for analyst processing the data. This in turn can lead to significant discrepancies in the SOT due to human error.

FIG. 4A is an end-to-end high level flow chart of an additional process disclosed herein for creating a list of exceptions. At 400A, new parents D-U-N-S Number is added to the GLR 402A. At 404A a new copy of the GLR is stored to a server. This new copy is a full download of all family trees from the GLR and is requested on a frequent basis such as, for example, daily, weekly or monthly. As soon as this second file is available, comparisons can be run between the new GRL copy 406A and the SOT 407A (the older GLR stored in Tweaq) to detect any changes in the two files in terms of added, deleted and relinked companies within all of the family trees. At 408A, the SOT is replaced with the new GLR copy. At 410A an exceptions file is created representing these changes. The exceptions file is added to the TWEAQ database at 412A. At 414A the TWEAQ user interface is accessed. At 416A an analyst investigates exceptions and confirms the exceptions in TWEAQ. A principal difference between the process of FIG. 4 and that of FIG. 4A, is that in FIG. 4A, the local SOT is updated when a new copy is received from the GLR.

In FIG. 4B, at 400, a GU change list is extracted by a linkage monitoring service that provides alerts when any changes are made to linkage for any monitored company, as part of a so called D&B Direct service. At 402B, using the linkage monitoring service, a full family tree for each GU is downloaded. This download can be, initially, any GU for which a linkage change has been made somewhere within the tree. Such download can be made on a daily basis. However, a full download of all trees can be used to create a local source of truth. At 404B, the downloaded trees are inserted into a relational database. At 406B a comparison is run against the SOT to detect any GU that has changed. At 410B, an exceptions list is generated including any GU that has changed. At 411B, trees in the SOT are replaced with newly downloaded family trees. The exceptions file is added to the TWEAQ database at 412B. At 414B the TWEAQ user interface is accessed. At 416B an analyst investigates exceptions and confirms the exceptions in TWEAQ.

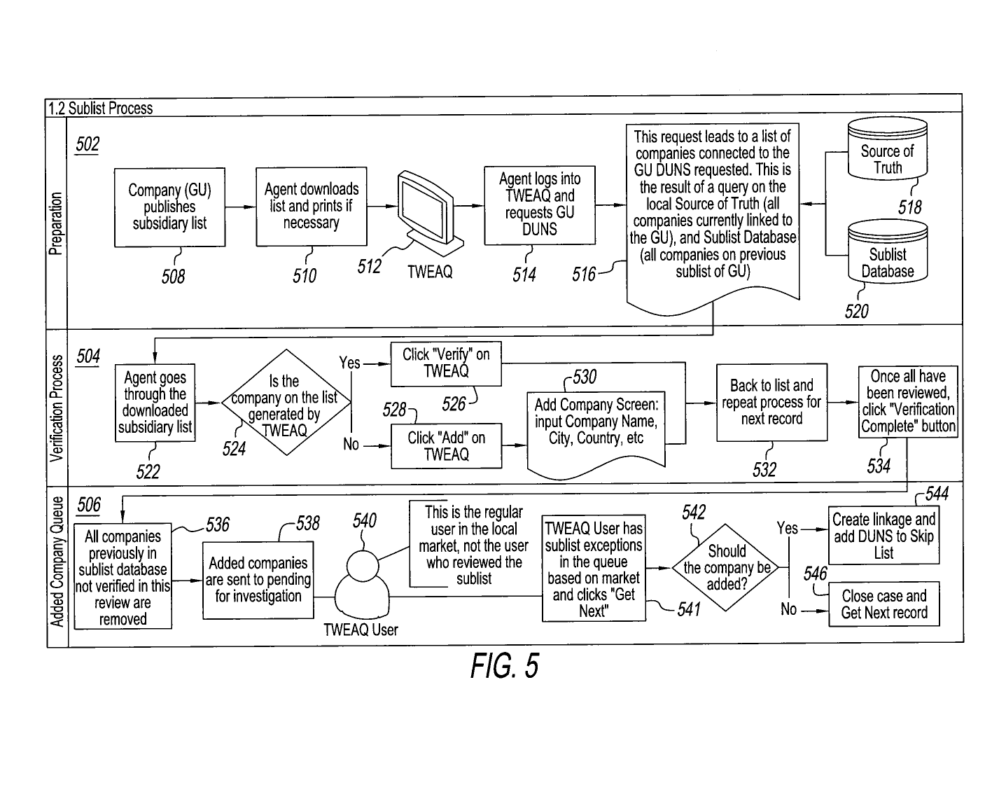

Regardless of which process is used, as described above with respect to FIG. 4, FIG. 4A or FIG. 4B, processing continues as described below with respect to FIG. 5.

FIG. 5 is a flow chart for a process for dealing with a subsidiary list, which is divided into three main parts including a preparation portion 502, a verification portion 504 and an added company queue portion 506. At 508, a company, generally the GU, publishes a subsidiary list. At 510, the list is downloaded and printed if necessary. At 512 the TWEAQ software is invoked. At 514 an agent may log into TWEAQ and request the GU D-U-N-S Number. At 516, this leads to a list of companies connected to the GU D-U-N-S requested. This is the results of a query on the local SOT 518 (all companies currently linked to the GU) and the subsidiary list database 520 (all companies on the previous subsidiary list of the GU).

At 522, the agent goes through the downloaded subsidiary list. At 524, a determination is made as to whether the company is on the list generated by TWEAQ. If the company is on the list generated by TWEAQ, at 526 the agent clicks on the TWEAQ user interface to verify this. If the company is not on the list generated by TWEAQ, then at 528 the agent clicks on the TWEAQ user interface for the company to be added to TWEAQ. At 530, a company screen is generated to which the company name, city, country and other identifying information is added. At 532, whether the company was on the list generated by TWEAQ or not, the process returns to the subsidiary list and repeats the steps described above for the next record. When all records have been verified the agent clicks a verification complete button on the TWEAQ user interface.

At 536, all companies previously in the subsidiary list database that were not verified in this review process remain linked in SOT. At 538, added companies are sent as pending for investigation, as discussed further below. At 540, a regular user in the local market (not the user or agent to review the subsidiary list) at 542, will have some sub list investigations in their queue based on the market. Here, the user can click a “get next” button. At 542, the user can decide whether the company should be added to the TWEAQ database. If Yes is selected, at 544, a linkage is created and the D-U-N-S Number is added is added to the “skip list”. Once an update has been made to a D-U-N-S Number contained in the SOT outside of TWEAQ, this D-U-N-S Number needs to be added to the skip list to avoid the update being generated as an exception. All items added to the skip list are run against the delta or change file to eliminate this change being created as an exception. If No is selected, the case is closed, and the next record is retrieved for processing.

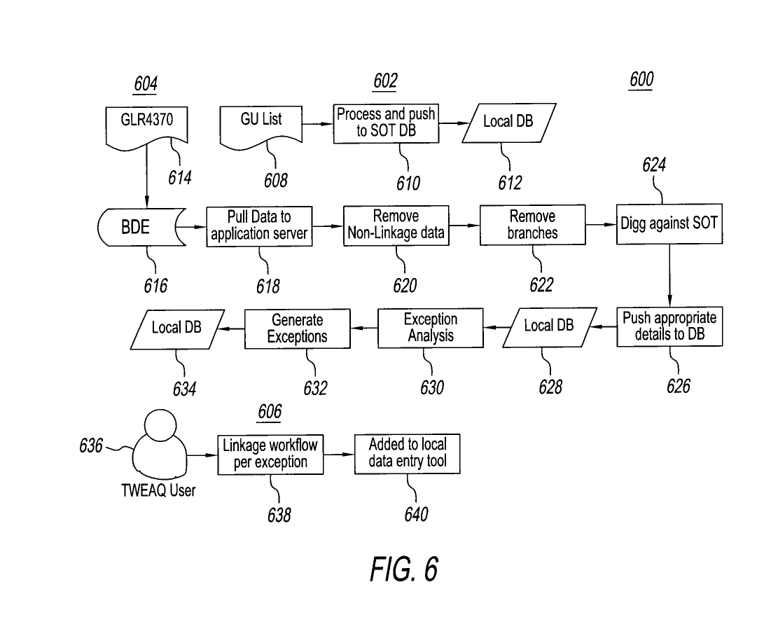

Referring to FIG. 6, the general system architecture 600 for the system and method disclosed herein is illustrated. There are three portions to this architecture including a data download portion 602, a data processing portion 604 and a workflow portion 606. Data download portion 602 starts with the GU list 608 which is processed and pushed to the SOT database at 610 to become part of the local database 612.

Data processing portion 604 begins with the GLR4370 database 614 and continues with bulk data exchange (BDE) at 616. At 618, data is pulled to the application server. At 620, non-linkage data is removed. At 622 branches are removed. At 624, a check is made for differences with respect to the SOT. At 626, the appropriate changes are pushed to the local database 628. At 630, exceptions analysis is performed to generate exceptions at 632 which are then stored in the local database at 634.

An agent 636 works on the exceptions at 638. The process data is added in the local data entry tool at 640 (e.g., DEWS-D-U-N-S Electronic Workstation).

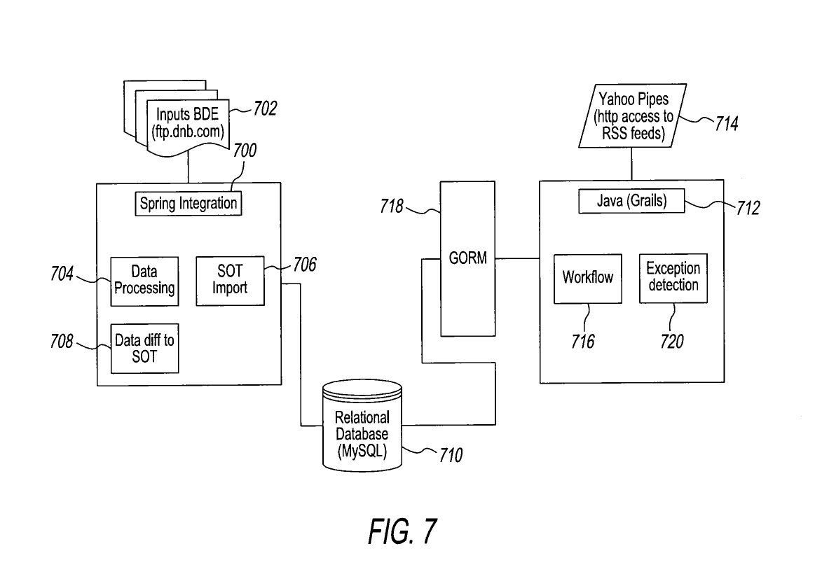

Referring to FIG. 7, data download flow for the system and method disclosed herein is illustrated. A change file, containing all the changes for the previous day, in COBOL format, is uploaded to the BDE each day. This file is in a format that ATLAS uses. Spring Integration 700 is configured to poll an FTP server 702 to download the change file from the BDE. Spring integration 700 is also configured to check for a file name pattern. If a new file that has not yet been processed is present, the new file is downloaded to local storage before data processing 704 begins. The SOT is imported at 706. Data differences are sent to the SOT at 708. The data is stored in a relational database 710. While Spring Integration 700 is preferred, Python and Grails 712 can work in conjunction to leverage MySQL as the bridge between the technologies. Data can also be obtained using an application such as Yahoo Pipes 714 to provide data from RSS feeds.

Grails 712 is used to provide the entire user workflow 716. A standard approach to Grails application development is used including Grails Object Relational Mapping or GORM 718. Exception data is detected at 720.

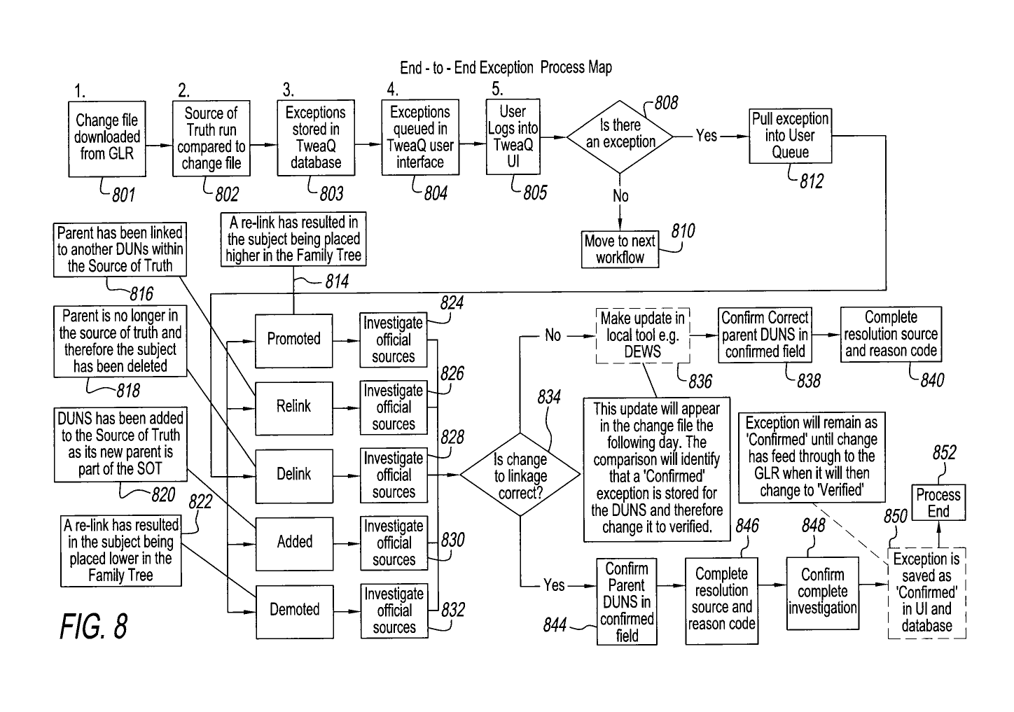

FIG. 8 is a flow chart illustrating the exception operation of FIG. 4 in accordance with the present disclosure. At 801, a change file is downloaded from the GLR. An FTP server is used for bulk data exchange (BDE). TWEAQ leverages Spring Integration to poll the FTP. When a file matching a particular pattern is detected, a download of the file to the application server is initiated. Reference is made to FIG. 6, steps 614 to 628 and FIG. 7, steps 700 and 702. At 802, the change file is compared to the SOT. Reference is made to FIG. 6, step 630 and FIG. 7, step 708. The SOT is the known truth for TWEAQ. Each delta or change file that is processed has two SQL queries run against it. The first query identifies all GU (Global Ultimate's) from the SOT and finds all records in the delta or change file that have a GU matching any of the GU's from the SOT. The second query identifies all Subject D-U-N-S Numbers from the SOT and finds all records that match these in the delta or change file. Once both queries are complete, they are joined together. This subset of data represents all records from the delta or change file that is in scope. For each of these records, a comparison is then run against the source of truth to check if any of the subject D-U-N-S Number, parent D-U-N-S Number or GU has changed in the change file. If any of these have changed, the type of linkage change is then identified (e.g., delink, re-link, added, promoted or demoted) and an exception record is created in the exception table of the database.

At 803, exceptions are stored in the TWEAQ database. Reference is made to FIG. 6, step 632. A check can be made to whether an update has been changed from “confirmed” to “verified”. At 804, exceptions are queued in the TWEAQ user interface. Reference is made to FIG. 6, steps 638 and 640. At 805, the user of the system logs into the TWEAQ user interface.

It is noted that FIG. 4 is an in-depth look at steps 801-805 of FIG. 8 and as such the following are directed to the same process: 801 corresponds to 404, 802 corresponds to 406/408, 803 corresponds to 412, 804 corresponds to 414 and 805 corresponds to 416.

At 808, a determination is made as to whether there is an exception; that is whether there is a difference between the data in the change file downloaded from GLR and the SOT. If there is no exception, at 810 the user can move to the next or a different workflow. However, if there is an exception, at 812 the data is pulled into the user queue for processing.

Exceptions can be treated in one of five ways. If a re-link has resulted in the subject being placed higher in the family tree, the subject is promoted at 814. If a parent has been linked to another D-U-N-S Number within the SOT, it is relinked at 816. If the parent is no longer in the SOT and therefore the subject has been deleted, the subject is delinked at 818. If the D-U-N-S Number has been added to the SOT, as its new parent is part of the SOT, the subject is added at 820. If a re-link has resulted in the subject being placed lower in the family tree, the subject is demoted at 822.

Regardless of the outcome, official sources are investigated at 824, 826, 828, 830 and 832, respectively, and a determination is made at 834 as to whether the change to the linkage is correct. If the change is not correct, at 836, a change is made using the local tool being used (e.g., DEWS). The update appears in the change file the following day. The comparison identifies that a “confirmed” exception is stored for the D-U-N-S Number and therefore it should be changed to verified as an exception. At 838, it is confirmed that the correct parent D-U-N-S Number is in the confirmed field. At 840, complete resolution source and reason code is provided and stored.

If the change to the linkage is determined to be correct at 834, at 844 the parent D-U-N-S Number is confirmed in the confirmed field. At 846, a resolution source and reason code is provided and stored. At 848 whether the determination at 834 was a Yes or a No, it is confirmed that the investigation is complete. At 850, the exception is saved as “confirmed” in the user interface and in the database. The exception will remain as confirmed until the change has been fed through to the GLR, when it will then change to “verified”. The process ends at 852.

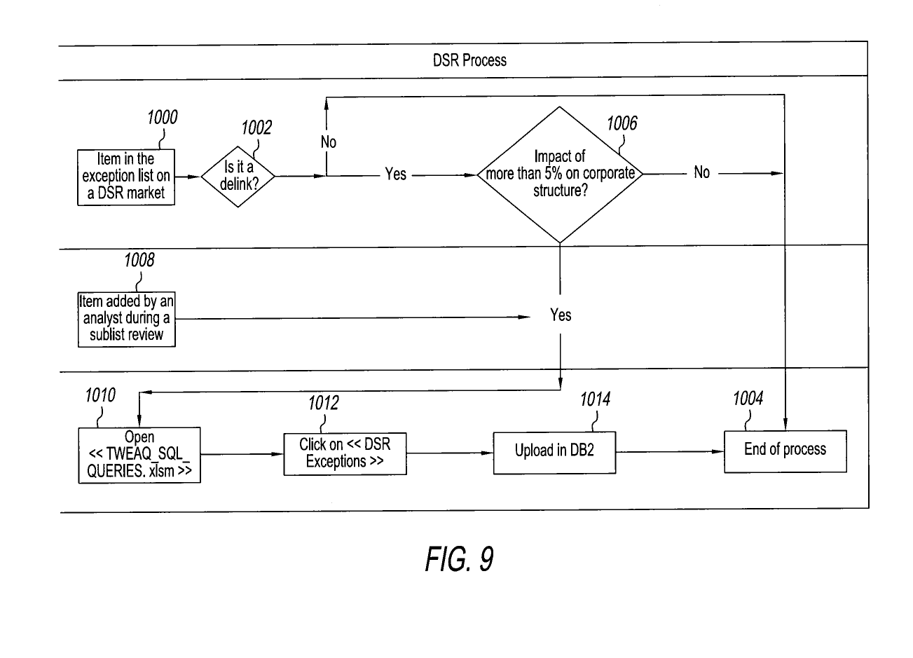

Referring to FIG. 9, a flow chart for a DSR market is illustrated. This is a D-U-N-S Number Support Request; request for investigation for markets outside of the local market. The process starts at 1000 wherein an item in the exception list is determined to be in a DSR market. A determination is made at 1002 as to whether a delink is appropriate. If it is not, the process ends at 1004. If a delink is appropriate, an inquiry is made at 1006 as to whether the delink will have an impact of more than five percent on the corporate structure. In some cases this is a question as to whether the change is financially material. If the impact on the corporate structure will not be more than five percent, the process ends at 1004. If the impact will be greater than five percent, an item may be added by an analyst at 1008 during a subsidiary list review. At 1010 an item is opened in TWEAQ_SQL_QUERIES.xlsm. At 1012, an agent clicks on a “DSR exceptions” button. At 1014, the exceptions data is uploaded to a database DB2. At 1004 the process ends.

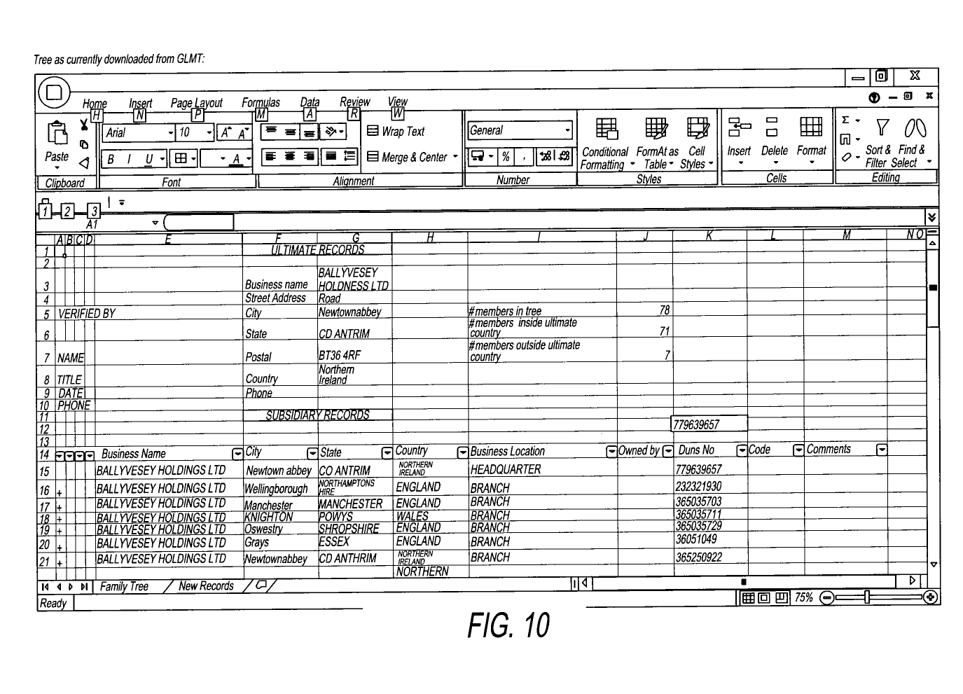

FIG. 10 is a screen shot of a data display based on family tree data downloaded from GLMT. The GU and subsidiary records are shown.

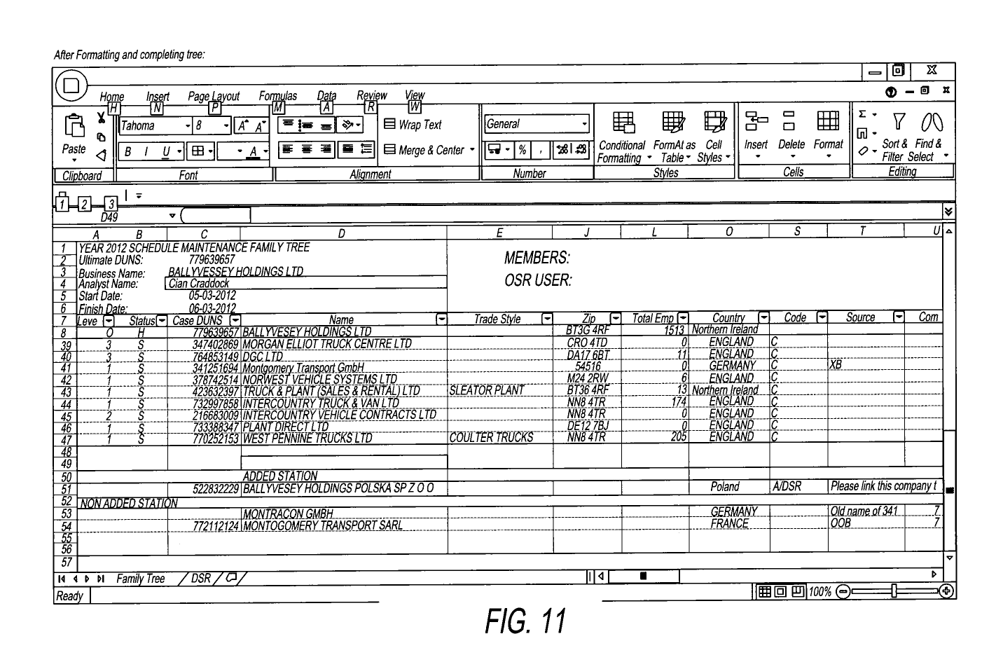

FIG. 11 is a screen shot of a data display showing the data of FIG. 11 after formatting and completing the family tree. Again, the GU and subsidiary records are shown.

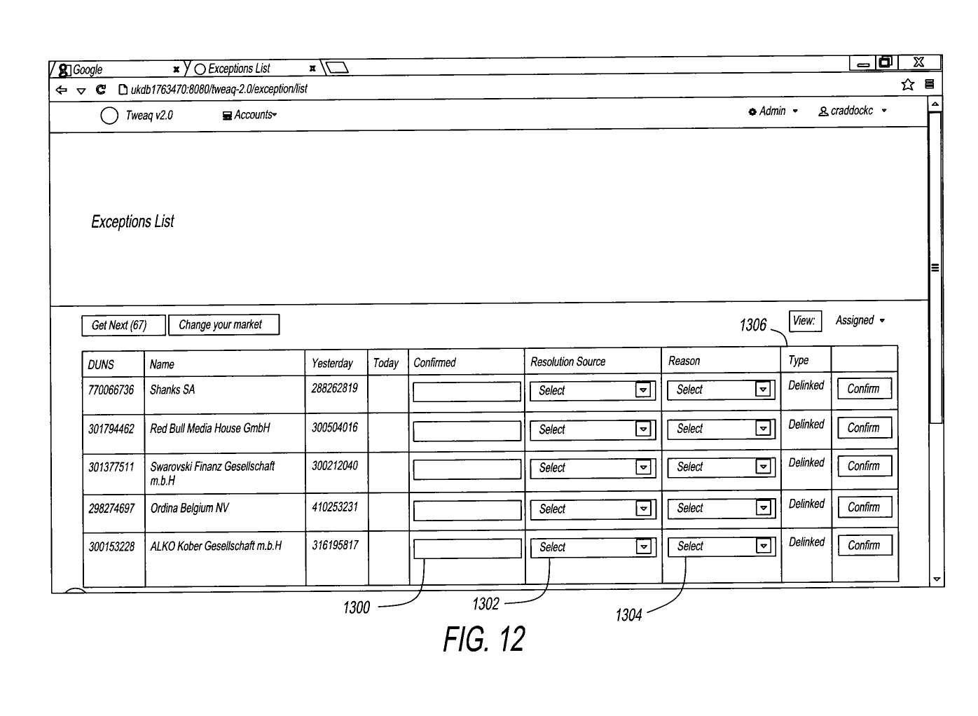

FIG. 12 is a screen shot of an exceptions list. There are fields for entering a confirmation 1300, a resolution source 1302, a resolution reason 1304 and the type of resolution 1306 (relink, delink, promote, demote and add) for each exception.

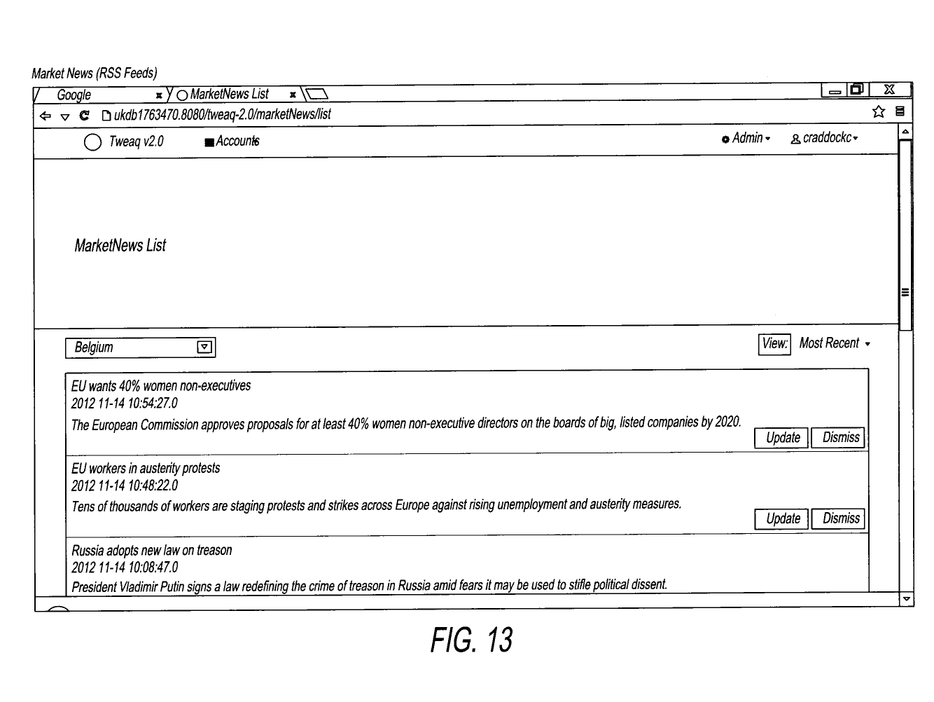

FIG. 13 is a screen shot of an RSS feed that provides input data to the system and method disclosed herein. This data can be used as a source to confirm linkage information.

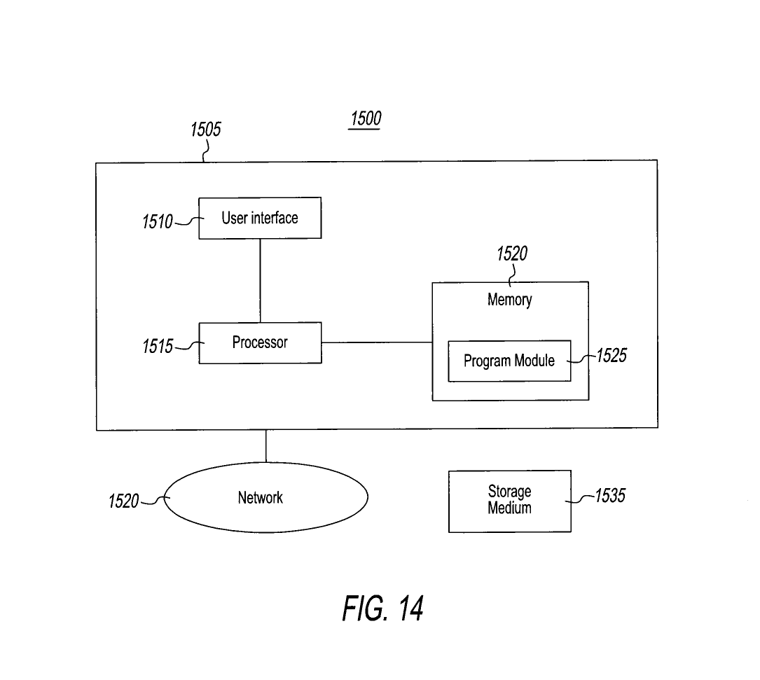

FIG. 14 is a block diagram of a system 1500, for employment of the presently disclosed embodiment. System 1500 includes a computer 1505 coupled to a network 1520, e.g., the Internet.

Computer 1505 includes a user interface 1510, a processor 1515, and a memory 1520. Computer 1505 may be implemented on a general-purpose microcomputer. Although computer 1505 is represented herein as a standalone device, it is not limited to such, but instead can be coupled to other devices (not shown) via network 1520.

Processor 1515 is configured of logic circuitry that responds to and executes instructions.

Memory 1520 stores data and instructions for controlling the operation of processor 1515. Memory 1520 may be implemented in a random access memory (RAM), a hard drive, a read only memory (ROM), or a combination thereof. One of the components of memory 1520 is a program module 1525.

Program module 1525 contains instructions for controlling processor 1515 to execute the methods described herein. For example, as a result of execution of program module 1525, processor 1515 performs steps accessing a change file from a linkage repository, comparing contents of the change file to a comprehensive corporate data file, thereby generating a change or exception to linkage for any corporate member stored in the comprehensive corporate data file; and storing the exception.

The term “module” is used herein to denote a functional operation that may be embodied either as a stand-alone component or as an integrated configuration of a plurality of sub-ordinate components. Thus, program module 1525 may be implemented as a single module or as a plurality of modules that operate in cooperation with one another. Moreover, although program module 1525 is described herein as being installed in memory 1520, and therefore being implemented in software, it could be implemented in any of hardware (e.g., electronic circuitry), firmware, software, or a combination thereof.

User interface 1510 includes an input device, such as a keyboard or speech recognition subsystem, for enabling a user to communicate information and command selections to processor 1515. User interface 1510 also includes an output device such as a display or a printer. A cursor control such as a mouse, track-ball, or joy stick, allows the user to manipulate a cursor on the display for communicating additional information and command selections to processor 1515.

Processor 1515 outputs, to user interface 1510, a result of an execution of the methods described herein. Alternatively, processor 1515 could direct the output to a remote device (not shown) via network 1520.

While program module 1525 is indicated as already loaded into memory 1520, it may be configured on a storage medium 1535 for subsequent loading into memory 1520. Storage medium 1535 can be any conventional storage medium that stores program module 1525 thereon in tangible form. Examples of storage medium 1535 include a floppy disk, a compact disk, a magnetic tape, a read only memory, an optical storage media, universal serial bus (USB) flash drive, a digital versatile disc, or a zip drive. Alternatively, storage medium 1535 can be a random access memory, or other type of electronic storage, located on a remote storage system and coupled to computer 1505 via network 1520.

It will be understood that the present disclosure may be embodied in a computer readable non-transitory storage medium storing instructions of a computer program that when executed by a computer system results in performance of steps of the system or method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for updating hierarchical family trees of organizations having related corporate members comprising:
a data processor;
a memory for storing instructions for operation of the data processor, the instructions causing the processor to perform steps of:
accessing a comprehensive linkage repository having corporate linkage data stored therein;
determining changes in the corporate linkage data;
generating a change file representative of the changes in the corporate linkage data;
using the change file to generate exceptions to the corporate linkage data stored in the repository;
generating an updated hierarchical family tree in accordance with the exceptions; and
storing the updated hierarchical family tree.

2. The system of claim 1, wherein further instructions cause the processor to perform steps of:
comparing contents of the repository at a first time to contents of the repository at a second time to generate the change file.

3. The system of claim 1, wherein further instructions cause the processor to perform steps of:
providing a copy of the data in the repository at a first time;
acquiring additional or changed corporate linkage data;
generating a changed copy of the data in the repository at a first time having the additional or changed data therein; and
comparing the changed copy of the data in the repository with the copy of the data in the repository at the first time to generate the change file.

4. The system of claim 1, wherein further instructions cause the processor to:
acquire a list of additional or changed corporate linkage data;
obtain from the repository the hierarchical family trees of organizations on the list;
store the hierarchical family trees of organizations on the list in a database; and
compare the stored hierarchical family trees to those of a database of known accuracy to generate the change file.

5. The system of claim 1, further comprising instructions for queuing said exception to a user interface for action by a user, so that the user makes a decision concerning said exception.

6. The system of claim 1, further comprising instructions for providing inquiry paths for consulting official sources to investigate whether said exception is correct.

7. The system of claim 6, further comprising instructions for receiving inputs for resolving an exception that is correct by an action selected from the group consisting of: promoting an entity, relinking an entity, delinking an entity, adding an entity, and demoting an entity.

8. The system of claim 7, further comprising instructions for making an inquiry as to the effect of said delinking an entity.

9. The system of claim 8, further comprising instructions for making an inquiry as to whether there are additional items to consider concerning the effect of said delinking an entity.

10. The system of claim 7, further comprising instructions for entering at least one decision selected from the group consisting of: a confirmation, a resolution source, a resolution reason, and a type of resolution, for said exception.

11. A method for updating hierarchical family trees of organizations having related corporate members comprising:
accessing a comprehensive linkage repository having corporate linkage data stored therein;
determining changes in the corporate linkage data;
generating a change file representative of the changes in the corporate linkage data;
using the change file to generate exceptions to the corporate linkage data stored in the repository;
generating an updated hierarchical family tree in accordance with the exceptions; and
storing on a storage medium the updated hierarchical family tree.

12. The method of claim 11, further comprising:
comparing contents of the repository at a first time to contents of the repository at a second time to generate the change file.

13. The method of claim 11, further comprising:
providing a copy of the data in the repository at a first time;
acquiring additional or changed corporate linkage data;
generating a changed copy of the data in the repository at a first time having the additional or changed data therein; and
comparing the changed copy of the data in the repository with the copy of the data in the repository at the first time to generate the change file.

14. The method of claim 1, further comprising:
acquiring a list of additional or changed corporate linkage data;
obtaining from the repository the hierarchical family trees of organizations on the list;
storing the hierarchical family trees of organizations on the list in a database;
comparing the stored hierarchical family trees to those of a database of known accuracy to generate the change file.

15. The method of claim 11, further comprising queuing said exception to a user interface for action by a user, so that the user makes a decision concerning said exception.

16. The method of claim 15, further comprising the user investigating the exception to assist in making the decision.

17. The method of claim 16, further comprising resolving an exception that is correct by an action selected from the group consisting of: promoting an entity, relinking an entity, delinking an entity, adding an entity, and demoting an entity.

18. The method of claim 17, further comprising making an inquiry as to the effect of said delinking an entity.

19. The method of claim 18, further comprising making an inquiry as to whether there are additional items to consider concerning the effect of said delinking an entity.

20. The method of claim 15, further comprising determining at least one decision selected from the group consisting of: a confirmation, a resolution source, a resolution reason, and a type of resolution, for each exception.

21. A computer readable non-transitory storage medium storing instructions of a computer program that when executed by a computer system results in performance of steps comprising:
accessing a comprehensive linkage repository having corporate linkage data stored therein;
determining changes in the corporate linkage data;
generating a change file representative of the changes in the corporate linkage data;
using the change file to generate exceptions to the corporate linkage data stored in the repository;
generating an updated hierarchical family tree in accordance with the exceptions; and
storing on a storage medium the updated hierarchical family tree.

22. The storage medium of claim 21, further comprising instructions for queuing said exception to a user interface for action by a user, so that the user investigates said exception.
